(19) United States
(12) Patent Application Publication
(10) Pub. No.: US 2012/0072524 A1
(43) Pub. Date: Mar. 22, 2012

(54) SYSTEM AND METHOD FOR RECORDING DATA IN A NETWORK ENVIRONMENT

(75) Inventors: Christopher J. White, Los Altos, CA (US); Jerry B. Scott, Los Altos, CA (US); Daniel R. Cook, San Jose, CA (US)

(73) Assignee: Cisco Technology, Inc.

(21) Appl. No.: 12/886,331

(22) Filed: Sep. 20, 2010

(51) Int. Cl. G06F 17/30; G06F 15/167

(52) U.S. Cl. 709/213; 707/812; 707/E17.005

(57) ABSTRACT

A method is provided in one example embodiment and includes receiving a signal to record a media stream, and recording the media stream in a first file that has a preconfigured length. If the media stream being recorded exceeds the preconfigured length then a second file is used to continue recording the media stream. The second file can have the same preconfigured length as the first file. The method also includes receiving a signal to stop recording the media stream, and storing metadata associated with the media stream in a database. In specific implementations, the metadata can include a unique file name associated with the media stream, a directory name of a disk directory, a first time indicative of when the recording started, and a second time indicative of when the recording ended.

### TECHNICAL FIELD

This disclosure relates in general to the field of communications, and more particularly, to recording data in a network environment.

### BACKGROUND

In today's marketplace, there is a growing volume of customer interactions and transactions such that companies have frequent contact with their customers. Proactively capturing and retaining customer interactions across endpoints is the basis for complying with government regulations, internal policies, dispute resolution, investigations, sales verification, etc. Hence, in order to meet governmental regulations, risk management, and/or liability requirements, many organizations require call recording protocols.

Any system that addresses call compliance issues should be scalable because customer service centers can have enormous capacity. Businesses can leverage networks to provide recording capabilities and efficient storage for their recordings. Typically, the call recordings are embodied in large files, which can be difficult to maintain, search, and/or retrieve. The ability to provide suitable recording architectures that operate efficiently in a network environment presents a significant challenge to component manufacturers, network operators, and service providers alike.

### BRIEF DESCRIPTION OF DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for recording data in a network environment;

FIG. 2 is a simplified block diagram illustrating possible example details associated with the communication system;

FIG. 3 is a simplified block diagram illustrating example logical connections for the communication system;

FIG. 4 is a simplified schematic illustrating an example disk directory associated with the communication system;

FIG. 5 is a simplified diagram of an example database table associated with the communication system; and

FIG. 6 is a simplified flowchart illustrating potential operations associated with the communication system.

### DETAILED DESCRIPTION OF EXAMPLE EMBODIMENTS

### Overview

A method is provided in one example embodiment and includes receiving a signal to record a media stream, and recording the media stream in a first file that has a preconfigured length. If the media stream being recorded exceeds the preconfigured length then a second file is used to continue recording the media stream. The second file can have the same preconfigured length as the first file. The method also includes receiving a signal to stop recording the media stream, and storing metadata associated with the media stream in a database. In specific implementations, the metadata can include a unique file name associated with the media stream, a directory name of a disk directory, a first time indicative of when the recording started, and a second time indicative of when the recording ended.

In other example implementations, the method can include allocating a port for the media stream; coupling the media stream to the port; coupling the port to a shared memory segment; and communicating the media stream to the shared memory segment through the port. A request handler element can be configured to locate available pairs of connector modules and recording modules for recording the media stream. In yet other examples, the media stream that is recorded is stored as separate files on a disk directory. The disk directory is provisioned with a time window that moves such that particular files are removed when they exceed the time window.

The media stream can be stored in a shared memory segment that can be accessed simultaneously by more than one process. In addition, the media stream can be retrieved from the shared memory segment for playback of the media stream. An identifier can be assigned to the media stream based on a time and a date on which the media stream was recorded. Additionally, active session information for the media stream can be stored in an in-memory list to be referenced by an application program interface function call. In more specific instances, the media stream includes video data that can be used to create a separate MP4 track within an MP4 file for particular video streams.

### Example Embodiments

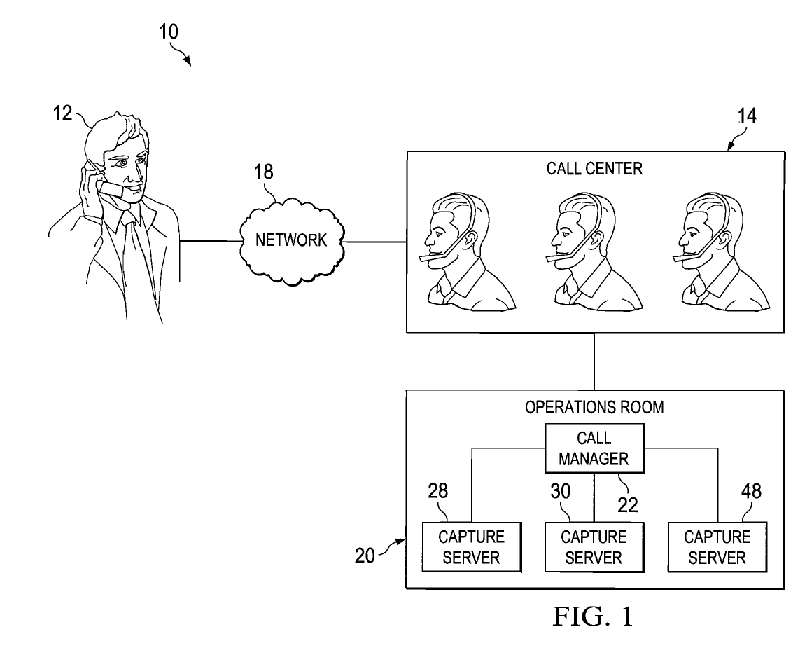

Turning FIG. 1, FIG. 1 is a simplified block diagram of an example embodiment of a communication system 10 that can provide scalable, on-demand recording capabilities in a network environment. Also being depicted in FIG. 1 is a set of possible users of communication system 10: including a caller 12 and operators in a call center 14. Communication system 10 can include a network 18 that enables communication between caller 12 and the operators of call center 14. FIG. 1 also includes a call manager 22, which may be a private branch exchange (PBX) server or a hosted software-based system. In the example embodiment of communication system 10, call manager 22 is connected to a capture server 28, a capture server 30, and a capture server 48 through a network interface over a local area network. Call manager 22, capture server 28, capture server 30, and capture server 48 are typically resident in an operations room 20 (e.g., proximate to call center 14).

In one particular example, the architecture of communication system 10 can be used in contact center/call center recording environments (e.g., involving compliance recording). Note that a robust call center could be receiving four to five calls per second such that any call architecture should be scalable. Regardless of the provisioning environment, the objective is to have a highly responsive, record-on-demand architecture. In typical call scenarios, an individual at an endpoint can be notified early in the call that the particular call is being recorded (e.g., for training purposes, for compliance issues, etc.). The full conversation can be recorded in response to an operator of call center 14 pressing a button on her endpoint (or through software, or performed automatically, etc.). Hence, in a typical communication session, caller 12 may be a customer that calls a merchant or service provider, where the customer can be connected to customer service representatives (i.e., operators in call center 14). Call manager 22 may be configured to record incoming calls, or to record certain calls only when specifically requested by an operator (or a supervisor, or based on speech detection, word triggers, etc.).

In one particular embodiment, communication system 10 is associated with a wide area network (WAN) implementation such as the Internet. In other embodiments, communication system 10 would be equally applicable to other network environments, such as a service provider digital subscriber line (DSL) deployment, a local area network (LAN), an enterprise WAN deployment, cable scenarios, broadband generally, fixed wireless instances, fiber to the x (FTTx), which is a generic term for any broadband network architecture that uses optical fiber in last-mile architectures. It should also be noted that the employees of a given call center can have any suitable network connections (e.g., intranet, extranet, virtual private network (VPN)) such that communication system 10 readily accommodates telecommuting scenarios for call centers equally.

Communication system 10 may include a configuration capable of transmission control protocol/internet protocol (TCP/IP) communications for the transmission and/or reception of packets in a network, particularly for Voice over IP (VoIP), Hypertext Transfer Protocol (HTTP), and Real-time Transport Protocol (RTP) applications. Communication system 10 may also operate in conjunction with a user datagram protocol/IP (UDP/IP) or any other suitable protocol, where appropriate and based on particular needs.

For purposes of illustrating certain example embodiments of communication system 10, it is important to understand the communications that may be traversing the network. The following foundational information may be viewed as a basis from which the present disclosure may be properly explained. RTP defines a standardized packet format for delivering audio and video over a network. RTP is used extensively in communication and entertainment systems that involve streaming media, such as telephony, video teleconference applications, and web-based push-to-talk features. For these applications, RTP carries media streams controlled by H.323, MGCP, Megaco, SCCP, or Session Initiation Protocol (SIP) signaling protocols: making it one of the technical foundations of the VoIP industry. RTP is designed for end-to-end, real-time, transfer of multimedia data. RTP can support data transfer to multiple destinations through multicast. An RTP session may be established for each multimedia stream, where a session consists of an IP address with a pair of ports. For example, audio and video streams typically have separate RTP sessions: enabling a receiver to deselect a particular stream. The ports that form a session are negotiated using other protocols such as SIP.

Protocols such as SIP, RTSP, H.225, and H.245 are used for session initiation, control, and termination. Other standards such as H.264, MPEG, and H.263 are used to encode the payload data. An endpoint can capture multimedia data before it is transmitted over the network, which may then be encoded and transmitted as RTP packets. Another endpoint may receive the RTP packets, decode them, and present the multimedia to the end user in the form of a telephone call, video conference, or similar communication session. Recording and maintaining the multimedia files presents a significant issue, as most recording architectures arbitrarily and haphazardly record and store this multimedia data

In accordance with one example embodiment, communication system 10 can provide an on-demand recording capability for a scalable number of communication sessions. The subsequent recordings can be exported, retrieved, maintained, etc., with minimal processing overhead. In one particular example, communication system 10 avoids managing individual files and specific retention criteria for individual recordings. Instead, communication system 10 can record media streams in preconfigured lengths, where a suitable naming convention can be used to quickly identify files of interest. Consider an example scenario that is illustrative of some of the capabilities of communication system 10.

Initially, a call can be received by call center 14, where it may be properly assigned to a given operator, a particular extension (e.g., ext. 123), etc. Subsequently, the operator (through pressing a button, or through software) can signal that she desires to record this particular call. The application within the PBX can request two RTP ports to which the recording would be sent. The assigned capture server can indicate a first available port recorder for this request. Essentially, the assigned capture server identifies the appropriate ports, where that information can be sent to the operator's phone, which can fork its media. The corresponding media can be sent to those two ports such that the media propagates to the IP address of the assigned capture server.

At some point, the call is terminated (e.g., the operator hangs-up her phone) and this condition is detected. The recording can be suitably stopped, and the location information relating to the database (in which the recording would be stored) can be maintained. Additionally, the database can include the corresponding start and stop times of the recording. The recording can also be designated by an identifier (i.e., a suitable name), which can be based on (or derived from) its associated recording date and time in particular implementations. Using a naming convention associated with a given date and time can allow for a quick searching for specific recordings (e.g., on a given date, at a given time of day, from a particular recorder, during a particular operator shift, etc.).

Accordingly, instead of having one file for each individual recording, communication system 10 has an amalgamation of recordings positioned as individual files. The architecture can effectively record in specific time intervals (e.g., five-minute chunks, thirty-second chunks, etc.). Indexes (e.g., as part of a directory) can then be used to indicate the location of specific recordings allocated amongst the particular time intervals (e.g., within the five-minute chunks). For retrieval purposes, an administrator can quickly evaluate a directory and readily glean information about which files make up a given recording. If there is a segment within the recording that is of interest to a given party, the architecture can pinpoint that particular file and remove the remainder of the recording date.

Hence, in contrast to other systems that store recordings as one continuous large file, or that store recordings individually in their own specific files (regardless of how small they may be), communication system 10 can record information in specified time intervals. For example, in the case of five-minute chunking, an hour-long conversation would include twelve, five-minute chunks. These twelve blocks can be provided as separate files. The hour-long conversation can be played continuously, where an administrator can remove bits that are not of interest.

In particular implementations, communication system 10 be configured to create an on-demand recorder architecture for recording multiple audio (G711 ulaw/alaw or G729A/B) and video (H.264) streams. The streams can be created as a single session, which can be played back in synchronization, or converted to an MP4 format file (or any other suitable format). Moreover, the architecture can record RTP audio/video streams from an endpoint without having to configure the endpoint. Further, communication system 10 can associate recorded streams as one session such that they can be played back in synchronization.

The architecture can also add a new stream to an in-progress session. In particular provisioning scenarios, the architecture can accommodate the recording start of four calls (two streams/call) per second (i.e., starting eight recordings per second). In cases where there are H.264 video streams to convert, the system is configured to create a separate MP4 track within the MP4 file for each video stream using an H.264 parser class and an MP4 file class. The resultant MP4 file can then be moved to a given memory element (i.e., a database) such that it can be uploaded using an HTTP uniform resource locator (URL).

In more specific implementations, a start application program interface (API) can be used such that that a given caller can specify a unique session identifier and the number of audio and video streams that need to be recorded. Call manager 22 is configured to find free recorder threads and, further, return the IP address of the recorder and the RTP ports assigned to each of the streams to be recorded. The active session information can then be stored in an in-memory list such that it can be referenced by subsequent API calls. Call manager 22 can also insert an entry into a given memory element (e.g., database) for a new virtual clip, where the session identifier can be used along with a track number to identify the virtual clip. There can similarly be an API to append a new stream to an existing session that performs the same functionality as the start API: provided the specified session is active.

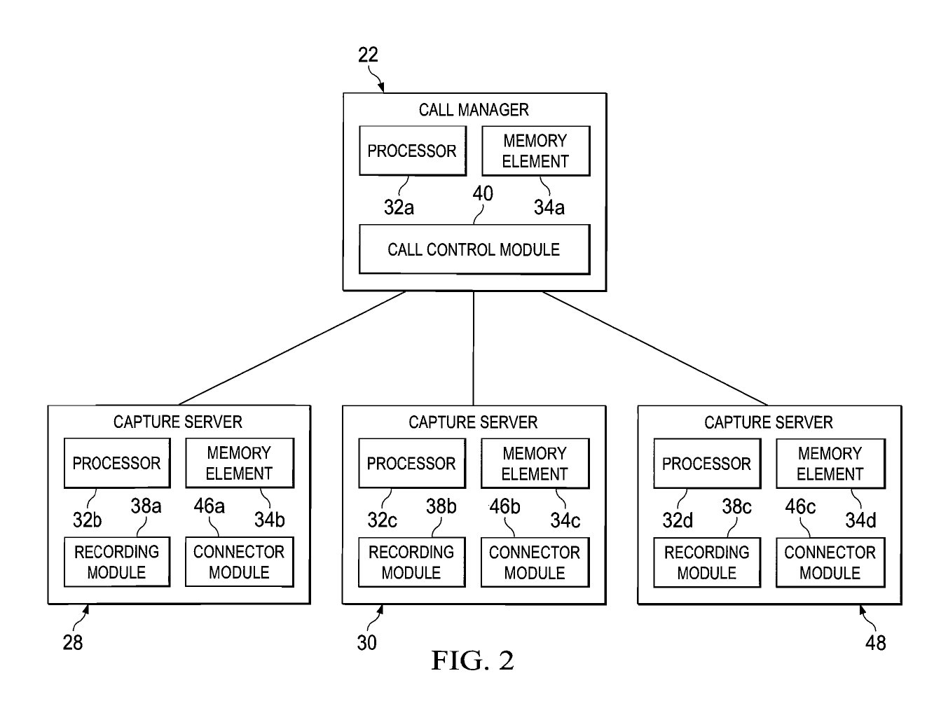

Turning to FIG. 2, FIG. 2 is a simplified block diagram illustrating one possible set of details associated with communication system 10. In this particular instance, call manager 22 includes a processor 32a, a memory element 34a, and a call control module 40. Capture server 28, capture server 30, and capture server 48 can include respective processors 32b-d, respective memory elements 34b-d, respective recording modules 38a-c, and respective connector modules 46a-c.

In one example implementation, call manager 22 and capture servers 28, 30, 48 are servers that cooperate in order to coordinate media recordings in their corresponding storage. More broadly, call manager 22 and capture servers 28, 30, 48 are network elements that generally manage (or that cooperate with each other in order to manage and/or coordinate) media recordings in a network environment. As used herein in this Specification, the term ‘network element’ is meant to encompass servers, application program interfaces (APIs), proxies, processors, modules, or any other suitable device, component, element, or object operable to exchange information in a network environment. These network elements may include any suitable hardware, software, components, modules, interfaces, or objects that facilitate the operations thereof. This may be inclusive of appropriate algorithms and communication protocols that allow for the effective exchange (reception and/or transmission) of data or information.

Call manager 22 and capture servers 28, 30, 48 may share (or coordinate) certain processing operations. Using a similar rationale, their respective memory elements may store, maintain, and/or update data in any number of possible manners. Additionally, because some of these network elements can be readily combined into a single unit, device, or server (or certain aspects of these elements can be provided within each other), some of the illustrated processors may be removed, or otherwise consolidated such that a single processor and/or a single memory location could be responsible for certain activities associated with endpoint management controls. In a general sense, the arrangement depicted in FIG. 2 may be more logical in its representations, whereas a physical architecture may include various permutations/combinations/hybrids of these elements.

In one example implementation, call manager 22 and capture servers 28, 30, 48 include software (e.g., as part of call control module 40, recording modules 38a-c, connector modules 46a-c, etc.) to achieve the intelligent media management operations, as outlined herein in this document. In other embodiments, this feature may be provided externally to any of the aforementioned elements, or included in some other network element (which may be proprietary) to achieve this intended functionality. Alternatively, several elements may include software (or reciprocating software) that can coordinate in order to achieve the operations, as outlined herein. In still other embodiments, any of the devices of the illustrated FIGURES may include any suitable algorithms, hardware, software, components, modules, interfaces, or objects that facilitate these endpoint management operations.

Note that the term ‘endpoint’ as used herein in this Specification is simply referring to any suitable device (e.g., telephone, a computing device, etc.), which can have various potential applications, to be used by any participants in the context of propagating information. Hence, the broad term ‘endpoint’ is inclusive of any devices that can be used to initiate or to foster a communication, such as any type of computer, camera, a personal digital assistant (PDA), a laptop or electronic notebook, a wireless access point, a residential gateway, a modem, a cellular telephone, an iPhone, an IP phone, iPad, or any other device, component, element, or object capable of initiating or facilitating voice, audio, video, media, or data exchanges within a network environment. Moreover, endpoints may be inclusive of a suitable interface to the human user, such as a microphone, a display, or a keyboard or other terminal equipment. The endpoints may also be any device that seeks to initiate a communication on behalf of another entity or element, such as a program, a database, or any other component, device, element, or object capable of initiating an exchange within a network environment. Additionally, the term ‘media stream’, as used herein in this document, refers to any type of numeric, voice, video, or audio streaming data, or any type of source or object code, or any other suitable information in any appropriate format that may be communicated from one point to another.

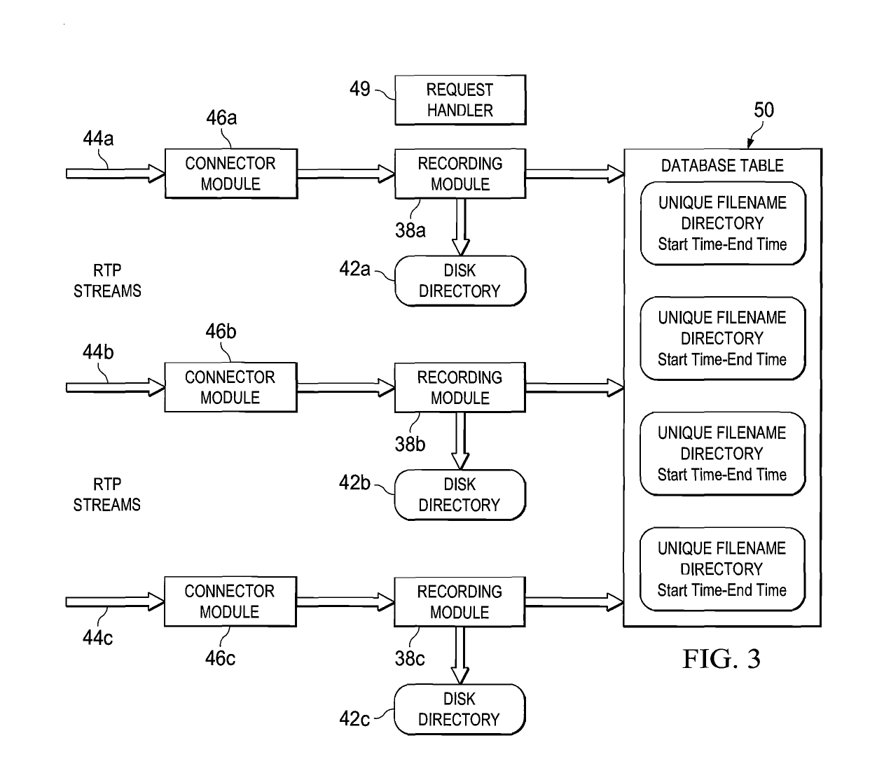

FIG. 3 is a block diagram illustrating example logical connections of components that may be included within communication system 10. Note that FIG. 3 includes some of the same components being depicted in FIG. 2. The components of FIG. 3 can be configured to record multiple incoming RTP streams 44a-c. In this particular example of FIG. 3, a set of connector modules 46a-c are used to receive the RTP streams, where connector modules 46a-c are coupled to respective recording modules 38a-c over a network connection. Connector modules 46a-c and recorder modules 38a-c can have a one-to-one association in particular instances, as is the case being illustrated in FIG. 3. In other scenarios, the connectors and recorders can be grouped together in any suitable fashion. Connector modules 46a-c, recorder modules 38a-c, and associated resources may be allocated at system startup. Connector modules 46a-c and recorder modules 38a-c may then be maintained in a ready state and, furthermore, start recording as soon as the first RTP packet arrives on a given interface.

A request handler 49 can be provisioned to locate the available pairs of connector modules and recording modules for recording a communication session. This provisioning can allow different sessions to record different numbers of RTP streams. In operation, request handler 49 can be configured to identify the required number of free connector/recorder pairs needed to record a multi-media session. Stated differently, different sessions can be recording different numbers of RTP streams. Request handler 49 can return the RTP ports associated with the capture server to which the RTP streams should be sent. RTP streams associated with the communication session can then be sent to these ports.

Each recording module 38a-c can be suitably coupled to a database table, which can further include a unique file name directory block that includes starting and ending times. Additionally, each recording module 38a-c can have its own storage segment in which recordings can be stored. The storage segments are illustrated in FIG. 3 as a set of disk directories 42a-c, which can be part of a suitable database. The number of simultaneous recording modules is easily configurable, and this can be based on a number of factors such as central processing unit (CPU) capacity, memory capacity, disk throughput, disk capacity, etc. The number of recorders is not necessarily dependent on the number of endpoints that can send streams. The maximum number of days a recording can be retained on disk is readily configurable by an administrator. A given recording time is not limited to a maximum size; rather, the maximum size that can be stored on disk for a recording is limited by the configured retention time.

Hence, each recording module can be allocated its own directory on disk and be sized depending on how many days of recording needs to be retained. The directory can be generically viewed as a file, where a given directory can include a mixture of recordings (i.e., recordings from multiple sessions involving participants on a call). An associated database can include information as to where each recording is located and, further, where the recording starts and stops. The database can effectively point to the exact location of recordings. Recordings may be indexed in a database, such as database table 50, which (for each file) may store the file's unique name, directory, start time, and end time. Database table 50 may also store retention policies, which may be system-wide, customized per session, designated for particular devices, environments, etc.

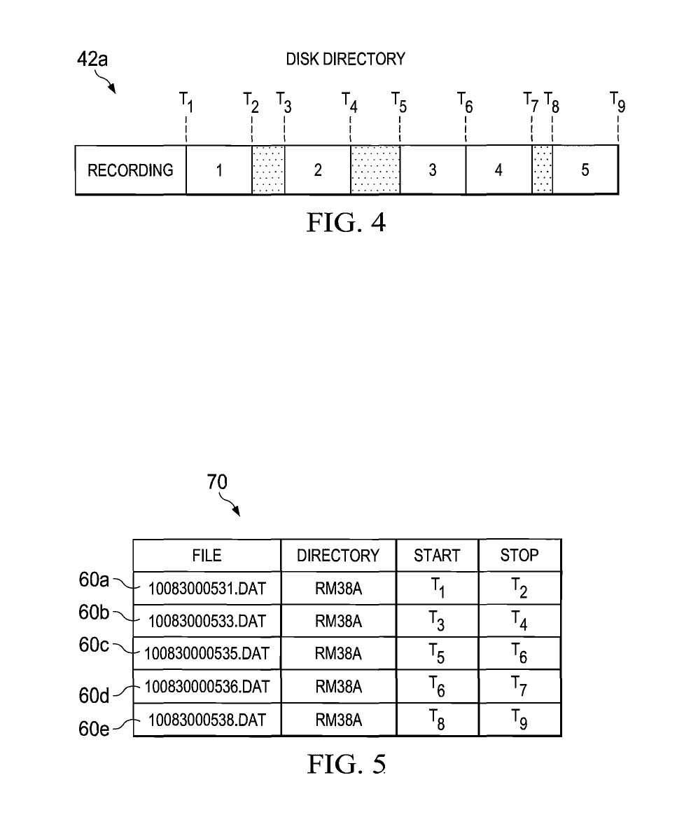

Turning to FIG. 4, FIG. 4 is a simplified schematic illustrating one example configuration of disk directory 42a. Disk directory 42a can be allocated to recording module 38a and, further, it can be sized based on a number of factors, including retention policies, storage capacity, etc. Recordings made by recording module 38a can be stored as separate files in disk directory 42a, where the size of each file can be limited by a configurable parameter. A recording is not necessarily limited to a maximum size, but the maximum size may be limited by the configurable retention time. The file name may be any arbitrary sequence of legal file name characters, or it may be based on the time created, a session identifier, or any other appropriate scheming and/or formatting. Similarly, the directory name itself can be any arbitrary sequence of characters, or it may be based on a systematic scheme, such as the date or identity of the recording module.

The disk directory can be further divided into subdirectories based on the recording date, or other appropriate criteria. Recordings can be suitably stored in separate files on a disk directory, which can have any appropriate range (e.g., from five seconds to five minutes in size). The disk directory can be stored on a disk (e.g., within a given capture server, or provisioned elsewhere). Note that this timing retention parameter can be varied considerably such that other types of data and information (e.g., video) can be accommodated by communication system 10. Thus, each directory can have its own subdirectories, which can identify the date and the time for its recordings. Recordings lasting more the five minutes can occupy multiple files on the disk.

In general terms, the directory can reflect a moving window in time such that when a file in the directory is outside of the current time window, the file can automatically be removed. The associated database entry can subsequently be updated or otherwise removed. Hence, files may be pruned based on configured time intervals that may be assigned by an administrator, a network operator, an individual operator at the call center, etc.

Consider an example scenario of a recorded call that lasts for approximately twenty minutes. The twenty-minute phone call consists of four, five-minute segments that were recorded. In this particular instance, the most relevant portion of the call (e.g., based on data mining, relevant background information being provided, etc.) occurs at the third, five-minute segment (e.g., at minute twelve). If the architecture were configured to simply record conversations as one large twenty-minute file, then that relevant portion would have to be extracted, processed, etc. in order to have a viable reproduction of this data segment. For example, the entire twenty-minute file would have to be downloaded and/or copied in order to retrieve the relevant portion (along with the relevant start and stop times, etc.). Subsequently, that relevant portion would have to be copied over to a new location and, further, saved as a new file. Such extensive processing and copying activity can be avoided by the architecture presented herein.

In a particular implementation of communication system 10, each recorded file is limited to a minimum of five seconds and a maximum of five minutes. Recordings that are longer than the maximum can be split into multiple files. For example, in the example illustration of FIG. 4, a single recording of twenty-three minutes can be stored in files #1-#5. Each of files #1-#4 would be five minutes long, and file #5 would be three minutes long. File #1 is indicated in FIG. 4 as the block between time T1 and time T2; file #2 is the block between time T3 and time T4; file #3 is the block between time T5 and time T6; file #4 is the block between time T6 and T7; and file #5 is the block between time T8 and T9. Other time blocks in FIG. 4, such as the block between time T2 and time T3, represent recordings from other sources or even other recording modules.

FIG. 5 is a diagram of an example embodiment of a database element 70 associated with database table 50. Database element 70 can include fields that store recording metadata, such as a unique file name (“FILE”), directory (“DIRECTORY”), start time (“START”), and end time (“STOP”). The FILE field can identify the name of a file in which a recording segment is stored by a given recording module. For example, the recording segment illustrated in FIG. 4 as file #1 may be identified in the FILE field of a first record 60a of database element 70 as ‘10083000531.dat’. Likewise, the DIRECTORY field can identify the name of the directory in which the file is stored and to which the recording module has been allocated. Referring again to file #1 from FIG. 4, the directory in which file #1 is stored can be identified in the DIRECTORY field of first record 60a of database element 70 as ‘RM38A.’ The START field and the STOP field can identify the start and end times of the recording that is stored in a file. Thus, using file #1 from FIG. 4 as an example, the start and end times could be stored in the START and STOP fields of first record 60a in database element 70 as time T1 and time T2, respectively. Subsequent recording segments can be similarly stored in records 60b-60e. Conceptually, the directory reflects a moving time window such that when a file in the directory is outside the current time window, the file can be automatically removed and the associated database entry can be updated or removed.

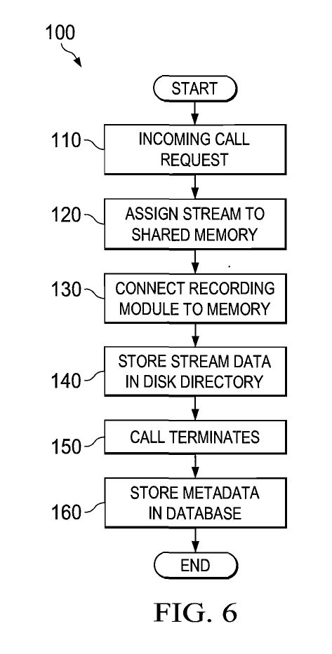

FIG. 6 is a simplified example flowchart 100 that illustrates an operation of communication system 10. At step 110, connector modules 46a-c can accept incoming requests from a call control module, such as call control module 40 (as illustrated in FIG. 2) for media streams (e.g., on-demand RTP streams 44a-c). A connector module can dynamically allocate ports and return the port addresses to call control module 40. Requests may be initiated manually by an operator through an endpoint (e.g., a button on the phone), or they may be automatically initiated for every communication session. A call control module may then relay the port addresses to the originating endpoint. An available connector module may also dynamically link the port addresses with a shared memory segment.

The originating endpoint may then connect to the port or ports and stream the data, which the connector module may then store in the shared memory segment at step 120. Storing the data in a shared memory segment enables the stream data to be accessed simultaneously by more than one process, such as a supervisor who is monitoring a call. At step 130, an available recording module can be connected to the shared memory segment. A recording module then stores the stream data in its associated disk directory at step 140. Audio and video data may be recorded on separate tracks in certain embodiments. When the recording session ends at step 150, the connector-recorder pair can be stopped and recording metadata (such as the file names, location, and recording times) can be stored in database table 50 at step 160.

Note that such a protocol can enable recordings to be made by any recorder module and, further, stored in any disk directory because they are stored with identifiers that enable the recordings to be quickly identified and retrieved. Although each disk directory can appear as one recording thread, it may contain multiple recordings with specific beginning and ending times from various recording sessions. By using an intelligent extraction operation, a recording thread can appear as an individual recording for the user. In addition, each recording in the recording thread can be exported into an MP4 file in certain implementations.

Note that in certain example embodiments, the functions described above may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIG. 2] can store data used for the operations described herein. This includes the memory element being able to store software, logic, code, or processor instructions that are executed to carry out the activities described above. A processor can execute any type of instructions associated with the data to achieve the operations detailed above. In one example, the processor [as shown in FIG. 2] could transform an element or an article (e.g., data) from one state or thing to another state or thing. In another example, the activities described herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures. For example, although previous discussions have focused on call center applications, any suitable recording environment would be amenable to the teachings of the present disclosure. Using similar reasoning, any type of audio and video recording protocols could leverage the features of communication system 10.

It is also important to note that the steps in the appended diagrams illustrate only some of the possible signaling scenarios and patterns that may be executed by, or within, communication system 10. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a signal to record a media stream;
recording the media stream in a first file that has a preconfigured length, wherein if the media stream being recorded exceeds the preconfigured length then a second file is used to continue recording the media stream, and wherein the second file has the same preconfigured length as the first file;
receiving a signal to stop recording the media stream; and
storing metadata associated with the media stream in a database.

2. The method of claim 1, further comprising:
allocating a port for the media stream;
coupling the media stream to the port;
coupling the port to a shared memory segment; and
communicating the media stream to the shared memory segment through the port.

3. The method of claim 1, wherein the media stream that is recorded is stored as separate files on a disk directory, and wherein the disk directory is provisioned with a time window that moves such that particular files are removed when they exceed the time window.

4. The method of claim 1, further comprising:
storing the media stream in a shared memory segment that can be accessed simultaneously by more than one process; and
retrieving the media stream from the shared memory segment for playback of the media stream, wherein an identifier is assigned to the media stream based on a time and a date on which the media stream was recorded.

5. The method of claim 1, wherein a request handler element is configured to locate available pairs of connector modules and recording modules for recording the media stream.

6. The method of claim 1, wherein the media stream includes video data that is used to create a separate MP4 track within an MP4 file for particular video streams.

7. The method of claim 1, wherein active session information for the media stream is stored in an in-memory list to be referenced by an application program interface function call.

8. The method of claim 1, wherein the metadata includes a unique file name associated with the media stream, a directory name of a disk directory, a first time indicative of when the recording started, and a second time indicative of when the recording ended.

9. Logic encoded in one or more tangible media that includes code for execution and when executed by a processor operable to perform operations comprising:
receiving a signal to record a media stream;
recording the media stream in a first file that has a preconfigured length, wherein if the media stream being recorded exceeds the preconfigured length then a second file is used to continue recording the media stream, and wherein the second file has the same preconfigured length as the first file;
receiving a signal to stop recording the media stream; and
storing metadata associated with the media stream in a database.

10. The logic of claim 9, the operations further comprising:
allocating a port for the media stream;
coupling the media stream to the port;
coupling the port to a shared memory segment; and
communicating the media stream to the shared memory segment through the port.

11. The logic of claim 9, wherein the media stream that is recorded is stored as separate files on a disk directory, and wherein the disk directory is provisioned with a time window that moves such that particular files are removed when they exceed the time window.

12. The logic of claim 9, the operations further comprising:
storing the media stream in a shared memory segment that can be accessed simultaneously by more than one process; and
retrieving the media stream from the shared memory segment for playback of the media stream, wherein an identifier is assigned to the media stream based on a time and a date on which the media stream was recorded.

13. The logic of claim 9, wherein a request handler element is configured to locate available pairs of connector modules and recording modules for recording the media stream.

14. The logic of claim 9, wherein the media stream includes video data that is used to create a separate MP4 track within an MP4 file for particular video streams.

15. The logic of claim 9, wherein active session information for the media stream is stored in an in-memory list to be referenced by an application program interface function call.

16. The logic of claim 9, wherein the metadata includes a unique file name associated with the media stream, a directory name of a disk directory, a first time indicative of when the recording started, and a second time indicative of when the recording ended.

17. An apparatus, comprising:
a memory element configured to store code;
a processor operable to execute instructions associated with the code; and
a connector module and a recording module configured to interface with the memory element and the processor such that the apparatus can:
receive a signal to record a media stream;
record the media stream in a first file that has a preconfigured length, wherein if the media stream being recorded exceeds the preconfigured length then a second file is used to continue recording the media stream, and wherein the second file has the same preconfigured length as the first file;
receive a signal to stop recording the media stream; and
store metadata associated with the media stream in a database.

18. The apparatus of claim 17, wherein the apparatus is further configured to:
allocate a port for the media stream;
couple the media stream to the port;
couple the port to a shared memory segment; and
communicate the media stream to the shared memory segment through the port.

19. The apparatus of claim 17, wherein the media stream that is recorded is stored as separate files on a disk directory, and wherein the disk directory is provisioned with a time window that moves such that particular files are removed when they exceed the time window.

20. The apparatus of claim 17, further comprising:
a request handler element is configured to locate available pairs of connector modules and recording modules for recording the media stream.
